(19) United States
(12) Patent Application Publication
(10) Pub. No.: US 2026/0236610 A1
(43) Pub. Date: Aug. 13, 2026

(54) APPLICATION DOMAIN-BASED GENERATION AND CALIBRATION OF SYNTHETIC DATASETS USING ARTIFICIAL INTELLIGENCE MODELS

(71) Applicant: Citibank, N.A., New York, NY (US)

(72) Inventors: James Myers, New York, NY (US); John E. Ortega, New York, NY (US)

(21) Appl. No.: 19/050,102

(22) Filed: Feb. 10, 2025

(51) Int. Cl. G06F 21/62

(52) U.S. Cl. CPC G06F 21/6254; G06F 21/6227

(57) ABSTRACT

The systems and methods disclosed herein can generate calibrated synthetic data with a measurable tracking difference/error. Using a dataset (e.g., actual data, data derived from actual data) including a set of attributes and/or a set of observed values of the set of attributes, the system can identify a subset of the set of attributes to be modified within the dataset. The system can generate a set of synthetic values of the identified subset of attributes using the dataset (e.g., based on an application domain of the dataset), the identified subset of attributes, and/or corresponding observed values of the identified subset of attributes. The system can generate a tracking relationship value between the set of synthetic data and the dataset for one or more benchmarks by comparing the observed values of the identified subset of attributes and the set of synthetic values of the identified subset of attributes.

### BACKGROUND

Synthetic data refers to artificially generated information that mirrors the statistical properties, patterns, and characteristics of real-world data. Organizations across various industries increasingly rely on synthetic data for testing, development, and analysis purposes, particularly when working with sensitive information such as personal information, financial records, or healthcare data. The generation and use of synthetic data enables organizations to perform data analysis, testing, and development activities while maintaining compliance with privacy regulations and data protection requirements. Synthetic data provides a viable alternative that allows organizations to conduct necessary operations without compromising individual privacy or violating data protection regulations. However, generating synthetic data that maintains both the characteristics of the actual dataset and a verifiable degree of anonymization presents significant technical challenges, particularly in ensuring that the synthetic data accurately reflects real-world conditions while preventing reverse engineering to identify the original data sources.

### BRIEF DESCRIPTION OF THE DRAWINGS

FIG. 1 illustrates an example environment of a synthetic data generation platform for generating synthetic data.

FIG. 2 illustrates an example environment of a calibration engine of the synthetic data generation platform of FIG. 1 for generating a measurable tracking relationship value of the generated synthetic data.

FIG. 3 is a flow diagram illustrating an example process of generating calibrated synthetic data using the synthetic data generation platform of FIG. 1.

FIG. 4 illustrates a layered architecture of an artificial intelligence (AI) model system that can implement the machine learning models of the synthetic data generation platform of FIG. 1.

FIG. 5 is a block diagram showing some of the components typically incorporated in at least some of the computer systems and other devices on which the synthetic data generation platform of FIG. 1 operates.

### DETAILED DESCRIPTION

Synthetic data can be deployed to validate mathematical models and to train machine learning models such as large language models (LLMs) or other generative AI (GenAI, GAI) models. Synthetic data is used in a variety of fields as a filter for information that would otherwise compromise the confidentiality of particular aspects of the data. In many sensitive applications, datasets theoretically exist but cannot be released to the general public. Further, synthetic data addresses the challenge of data scarcity, which is common when implementing modern approaches to training LLMs or other generative AI models. Data scarcity occurs when there is an insufficient amount of real-world data available for analysis, training AI models, and other operations.

However, continuously using inaccurate synthetic data to, for example, train artificial intelligence (AI) models, increases the risk of model degradation. Inaccurate synthetic data includes data that, for example, has been generated/developed with incorrect assumptions, lacks variability, or contains errors and biases that are absent from original data (e.g., actual data, copies of the actual data, anonymized data, depersonalized data, and so forth). If an AI model continuously intakes inaccurate synthetic data, the AI model's performance and accuracy can degrade due to the over-reliance on artificial data that may not capture the nuances of real-world data. Over-reliance can lead to biased or inaccurate predictions and decisions. Another challenge is obtaining cross-border approval for the use of actual data. Different countries have varying regulations and standards for data privacy and protection, and synthetic data must comply with different regulations to be used legally. Navigating the regulatory landscapes can be complex and time-consuming, potentially delaying the deployment of AI models.

Attempting to create synthetic data that accurately reflects real-world conditions while ensuring compliance with privacy regulations presents significant technical challenges. Creating such data requires addressing several limitations in conventional approaches to data generation, such as the difficulty in maintaining the statistical properties of the original data while ensuring anonymization. Unlike traditional data anonymization methods that may simply remove or mask personal identifiers, synthetic data generation creates entirely new data points that mimic the original data's characteristics and cannot be reengineered to trace back to, for example, customers or other personally identifiable information (PII) or personal information (PI). Conventional methods often struggle to balance the need for data utility with the requirement for privacy, leading to either overly generalized data that lacks detail or insufficiently anonymized data that poses privacy risks.

To address these technical challenges, multiple design approaches were evaluated. For example, evaluations and analysis included generating synthetic data to reflect the statistical properties and patterns of the original data. However, a significant challenge remained: there was no measure of how good the synthetic data was, nor was there a method to track the differences between the original and synthetic data. Without a reliable measure of the quality of synthetic data, it was challenging to ensure that the generated data captured the nuances of the original data.

As such, the inventors have developed a system for generating calibrated synthetic data using an AI model (e.g., generative model, large language model, machine-learning model) (hereinafter the “synthetic data generation platform”). The synthetic data generation platform can use a dataset, which includes actual data comprising a set of attributes and/or a set of observed values for these attributes, to identify a subset of the attributes to be anonymized and/or depersonalized within the dataset (e.g., user identifiers such as name, address, etc., passwords, and so forth). Once the subset of attributes to be anonymized and/or depersonalized is identified, the synthetic data generation platform can generate a set of synthetic values for the attributes. Synthetic values can be generated directly from the actual data, with built-in provisions to anonymize and/or depersonalize the data during the creation process. The synthetic data generation platform can ensure that the synthetic data maintains the statistical properties and patterns of the original dataset while maintaining individual privacy.

In some implementations, synthetic data generation platform can first anonymize and/or depersonalize the actual data by, for example, removing any personal information. Once the data is anonymized and/or depersonalized, synthetic values are created from the depersonalized dataset. The two-step approach ensures that the synthetic data is derived from a dataset that has already been stripped of sensitive information, thereby lowering the risk of re-identification via reengineering. Additionally or alternatively, the synthetic data generation platform can create a reusable mask for depersonalizing the observed values. The mask can be saved and subsequently applied to other data (e.g., data that is similar to the original data, the original data itself, different data, and so forth). By creating and saving a depersonalization mask, the synthetic data generation platform can consistently anonymize/depersonalize across multiple datasets.

One of the advantages of the synthetic data generated off of depersonalized/anonymized data is that the synthetic data cannot be reverse-engineered. Unlike depersonalized or anonymized data, which can potentially be re-identified when combined with other databases or sources, by first depersonalizing or anonymizing the actual data and then creating synthetic data from it, the synthetic data generation platform ensures that the synthetic data cannot be traced back to the PII of the original customers. Thus, the synthetic data generation platform alleviates significant privacy regulatory concerns, as it prevents the possibility of re-engineering the synthetic data to uncover sensitive information of the clients.

To assess the accuracy and fidelity of the synthetic data, the synthetic data generation platform can generate a tracking relationship value (e.g., a tracking difference, a tracking error, a tracking differentiator, tracking overlap percentage, or the like) between the original data (e.g., actual data, anonymized data, depersonalized data, and so forth) and the synthetic data. The tracking relationship value is a quantifiable metric comparing the synthetic data against the actual data across various scopes (e.g., at a variable level, at a segment—or group of variables—level, at an overall dataset level, and so forth). For example, if a user requests Kansas City credit card data from the last 48 hours, the synthetic data generation platform can not only generate synthetic data but also output that the synthetic data is within, for example, 1% of the actual data overall. Furthermore, the synthetic data generation platform can provide specific tracking relationship values for individual characteristics, such as, for example, a 0.1% tracking error for the “age” characteristic and/or a 2% tracking error for the “income” characteristic. This level of detailed comparison ensures that the synthetic data closely mirrors the actual data, making the synthetic data commercially scalable and highly reliable for various applications.

The tracking relationship value can be calculated by comparing the observed values of the identified subset of attributes with the corresponding synthetic values. The comparison can be performed against one or more benchmarks (e.g., certain variables to compare), providing a quantifiable metric that indicates how closely the synthetic data mirrors the real-world data. The benchmarks can be determined using an associated scenario (e.g., application domain) of the dataset. For example, in a financial field, the variables gender, income, geographical location, and so forth can be included in the benchmarks. If the tracking relationship value exceeds a certain threshold (e.g., specified by the user, specified by a guideline, dynamically generated), the synthetic data generation platform can regenerate the synthetic values using, for example, different parameters or weights. The threshold can be a threshold value, a threshold condition, a range of threshold values, and so forth.

By comparing the synthetic values with the observed values against established benchmarks, the synthetic data generation platform can quantify how closely the synthetic data mirrors the real-world data. Additionally, regenerating synthetic values if the tracking relationship value exceeds a certain threshold mitigates the risk of over-reliance on synthetic data. Furthermore, the synthetic data generation platform can ensure compliance with varying guidelines by providing a quantifiable method for assessing and validating synthetic data, thus simplifying the process of obtaining cross-border approval and accelerating the deployment of models trained on synthetic data.

While the current description provides examples related to LLMs, one of skill in the art would understand that the disclosed techniques can apply to other forms of machine learning or algorithms, including unsupervised, semi-supervised, supervised, and reinforcement learning techniques. For example, the disclosed intent-based data generation platform can evaluate model outputs from support vector machine (SVM), k-nearest neighbor (KNN), decision-making, linear regression, random forest, naïve Bayes, or logistic regression algorithms, and/or other suitable computational models.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Example Implementations of the Synthetic Data Generation Platform

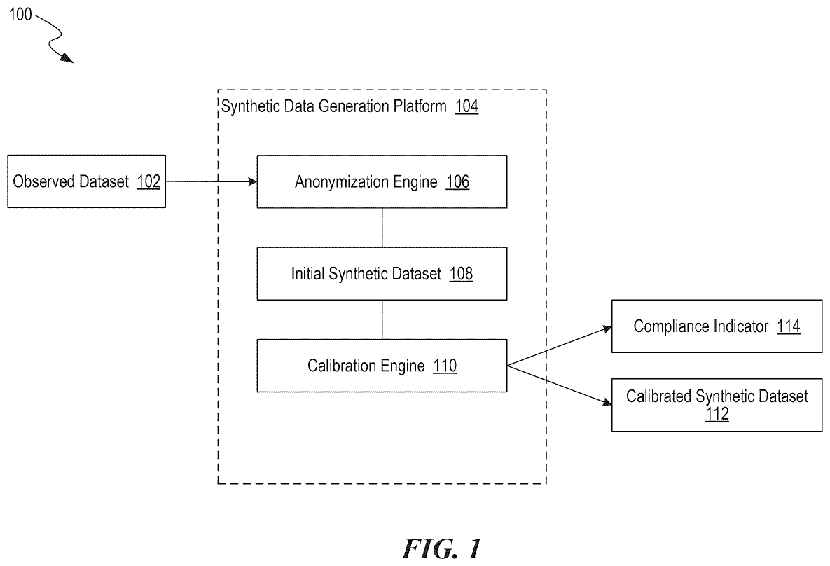

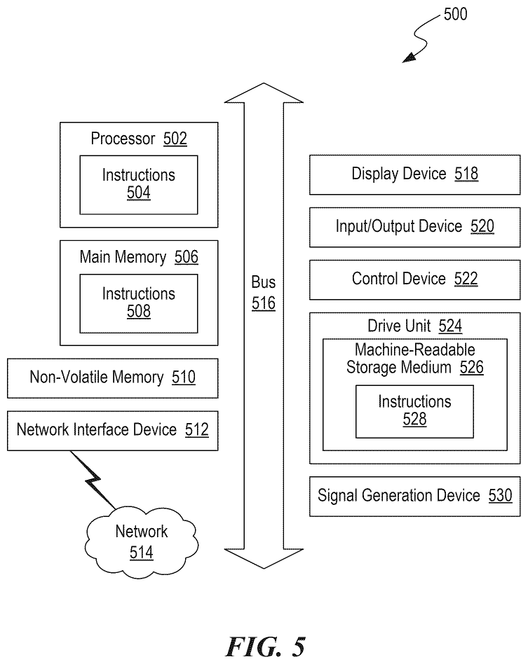

FIG. 1 illustrates an example environment 100 of a synthetic data generation platform 104 for generating synthetic data. The environment 100 includes an observed dataset 102 (e.g., data associated with actual data), the synthetic data generation platform 104, calibrated synthetic dataset 112, and compliance indicator 114. The synthetic data generation platform 104 can include anonymization engine 106, which can output initial synthetic dataset 108, and calibration engine 110. The synthetic data generation platform 104 is implemented using components of the example computer system 500 illustrated and described in more detail with reference to FIG. 5. Implementations of the environment 100 can include different and/or additional components or can be connected in different ways.

The observed dataset 102 refers to data associated with the original data and/or actual data collected from real-world sources (e.g., the original/actual data, copies of the original/actual data, data generating using the original/actual data, and so forth), which may contain sensitive information such as personal information. The observed dataset 102 serves as the input for the synthetic data generation platform 104. In some implementations, the observed dataset 102 can be multimodal, text, computer data, code, audio, image, video, and so forth. The synthetic data generation platform 104 is a computer system (e.g., computer system 500) that generates synthetic datasets to mimic and/or replicate one or more properties or representations (e.g., statistical properties) of the observed dataset 102 while ensuring that the synthetic data cannot be traced back to the original data. Thus, the synthetic data generation platform 104 is enabled to ensure compliance with guidelines and/or regulatory frameworks that define how personal data is to be handled, stored, shared, and so forth (e.g., guidelines that restrict the transfer of personal data across borders unless certain conditions are met). By generating synthetic data that mimics the statistical properties of the observed dataset, the synthetic data generation platform 104 can anonymize and/or depersonalize information based on the guidelines for different geographical locations or entities. In some implementations, the synthetic data generation platform 104 can be integrated with cloud-based services and/or be executed from local server.

The anonymization engine 106 within the synthetic data generation platform 104 transforms data within the observed dataset 102 into synthetic data values of the initial synthetic dataset 108 by anonymizing and/or depersonalizing the data. The anonymization engine 106 can apply one or more anonymization methods to ensure that the synthetic data does not contain any personal information. The initial synthetic dataset 108 refers to the output generated by the anonymization engine 106. Anonymization and depersonalization refer to transforming data such that one or more entities to whom the data pertains cannot be identified, either directly or indirectly (e.g., a certain user identifier, an Internet Protocol address, and so forth). Anonymization and depersonalization can include data masking (i.e., where sensitive information is replaced with random characters or symbols), pseudonymization (i.e., where identifiers are replaced with pseudonyms), and generalization (i.e., where detailed data is replaced with broader categories), and so forth.

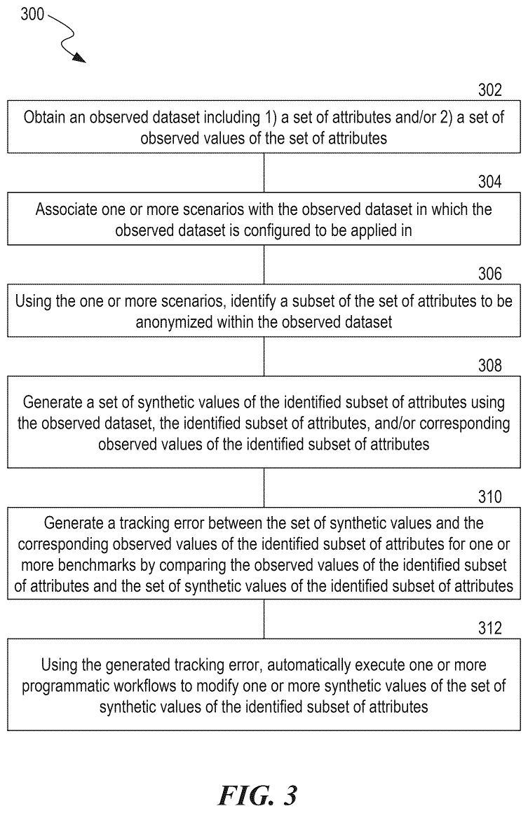

For text data, the synthetic data generation platform 104 can anonymize and/or depersonalize sensitive information in documents, emails, and other textual content/sources while preserving the context and/or structure of the text. For audio data, the synthetic data generation platform 104 can generate synthetic audio files that maintain the acoustic properties (e.g., pitch, tone, rhythm) of the original recordings. With image data, the synthetic data generation platform 104 can create synthetic images that replicate the visual characteristics (e.g., color distribution, texture, spatial relationships) of the original images. Similarly, for video data, the platform can generate synthetic videos that retain the temporal and spatial properties (e.g., same motion patterns, lighting conditions) of the original footage. Further examples of generated synthetic data are discussed with reference to FIG. 3.

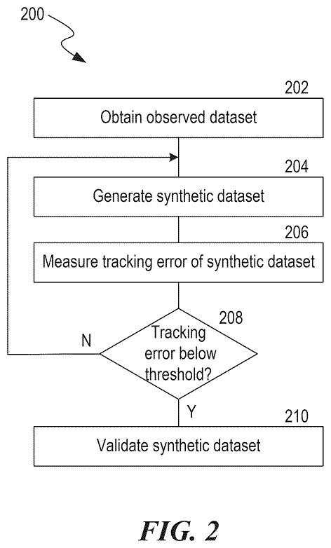

In some implementations, the initial synthetic dataset 108 can be evaluated against one or more calibration (e.g., validation) checks to ensure that the initial synthetic dataset 108 satisfies one or more criteria (e.g., benchmarks such as statistical similarity to the observed dataset, preservation of data distributions, compliance with guidelines, and so forth) before being output from the synthetic data generation platform 104. For example, the calibration engine 110 can validate that the initial synthetic dataset 108 has a tracking relationship value below a certain threshold using methods discussed with reference to FIG. 2. The calibration engine 110 refines the initial synthetic dataset 108 to produce a calibrated synthetic dataset 112. In some implementations, the calibration engine 110 can use machine learning algorithms to iteratively adjust the initial synthetic dataset 108.

The synthetic data generation platform 104 can generate a compliance indicator 114 (e.g., an audit, a compliance report, and so forth) of observed dataset 102, which can be an artifact (e.g., text document, image, video, audio) generated by the synthetic data generation platform 104 that indicates the synthetic data's compliance with one or more guidelines (e.g., privacy regulations). The compliance indicator 114 can include metrics such as a tracking relationship value determined using methods discussed with reference to FIG. 2 and FIG. 3.

FIG. 2 is a block diagram illustrating an example process 200 performed by the calibration engine of the synthetic data generation platform 104 of FIG. 1 for generating a measurable tracking relationship value of the generated synthetic data. The calibration engine can be implemented on a terminal device, a server, or on a telecommunications network core. Implementations can include different and/or additional blocks or can perform the operations of the blocks in different orders.

In block 202, the synthetic data generation platform 104 can obtain an observed dataset (e.g., observed dataset 102 in FIG. 1). Users can input the observed dataset directly into the synthetic data generation platform 104 (e.g., by uploading files in formats such as CSV, JSON, Excel, and so forth). In some implementations, the synthetic data generation platform 104 can schedule regular data imports from specified sources at specified intervals (e.g., daily, weekly). Additionally, the synthetic data generation platform 104 can integrate with external systems and databases through Application Programming Interface (API) calls, allowing the synthetic data generation platform 104 to obtain data programmatically.

In block 204, the synthetic data generation platform 104 can generate a synthetic dataset (e.g., initial synthetic dataset 108 in FIG. 1). The synthetic dataset is an artificially generated dataset that mirrors the statistical properties, patterns, and characteristics of the observed dataset. For example, the synthetic data generation platform 104 can use one or more non-generative or generative models to generate the synthetic dataset. In some implementations, the synthetic dataset can be generated using machine learning models that are trained on the observed dataset. The models can learn the underlying patterns and relationships in the data and use the underlying patterns and relationships to generate new, synthetic data points that maintain similar statistical properties as the observed dataset. Further methods of generating the synthetic dataset are discussed with reference to FIG. 3.

In block 206, the synthetic data generation platform 104 can measure a tracking relationship value of one or more portions of the synthetic dataset (e.g., a specific characteristic, a group of characteristics, the entire dataset, and so forth). The tracking relationship value is a quantifiable metric. The tracking relationship value may be used to assess the fidelity and/or reliability of the synthetic dataset. The tracking relationship value can measure the difference between the synthetic dataset and the observed dataset to evaluate how accurately the synthetic data reflects the real-world conditions represented by the original data. In some implementations, the tracking relationship value can be calculated using statistical methods such as mean squared error or other distance metrics. For example, the synthetic data generation platform 104 can compare the distributions of the observed and synthetic datasets to determine a degree of similarity between them. Further methods of measuring the tracking relationship value are discussed with reference to FIG. 3.

In block 208, the synthetic data generation platform 104 determines whether the tracking relationship value is below a threshold (e.g., a predefined error value). The threshold is a predefined value that serves as a benchmark for, for example, the acceptable level of tracking error. If the tracking error of the synthetic dataset is below the threshold, it indicates that the synthetic data is sufficiently accurate. In some implementations, the threshold can be dynamically adjusted based on the specific context of the application or the sensitivity of the data.

If the tracking relationship value is below the threshold, the synthetic data generation platform 104 validates the synthetic dataset in block 210. If the tracking relationship value is below the threshold, the synthetic data generation platform 104 regenerates the synthetic dataset by proceeding back to block 204. In some implementations, the synthetic data generation platform 104 can use different algorithms or parameters to generate the synthetic dataset. Additionally, the synthetic data generation platform 104 can adjust hyperparameters, such as learning rates or batch sizes, to improve the performance of the generative models. The synthetic data generation platform 104 can iteratively generate new synthetic datasets, measure their tracking relationship values, and refine the data until the tracking relationship value falls below the acceptable threshold.

In some implementations, the synthetic data generation platform 104 can be used to obtain cross-border approval for actual data using the generated synthetic dataset. For example, the synthetic dataset can be used to demonstrate compliance in one or more scenarios (e.g., an application domain, a target application, a particular location, a particular use case, a particular regulation, such as the European Union's General Data Protection Regulation (GDPR)). To ensure the synthetic data is a reliable proxy for the actual data and complies with applicable regulations associated with cross-border approval, the synthetic data generation platform 104 can compute the deviation between the actual and synthetic data (e.g., block 208). The synthetic data generation platform 104 can measure the statistical differences between the two datasets, such as mean, variance, and distribution, and so forth. In some implementations, the synthetic data generation platform 104 can evaluate the generated synthetic dataset against one or more benchmarks (e.g., criteria in privacy regulations). If the deviation between the actual and synthetic data exceeds a certain threshold, which may indicate a risk of re-identification the synthetic data generation platform 104 can adjust the synthetic dataset to comply with local regulations.

FIG. 3 is a flow diagram illustrating an example process of generating calibrated synthetic data using the synthetic data generation platform 104 of FIG. 1. The synthetic data generation platform 104 can be implemented on a terminal device, a server, or on a telecommunications network core. Implementations can include different and/or additional operations or can perform the operations in different orders.

In operation 302, the synthetic data generation platform 104 can obtain (e.g., from a computing device), an observed dataset (e.g., actual data) including 1) a set of attributes and/or 2) a set of observed values of the set of attributes. In some implementations, the synthetic data generation platform 104 can obtain the observed dataset directly from a computing device, such as a user's local machine, a server, or a cloud storage service. Further examples of observed datasets and methods of obtaining the observed dataset are discussed with reference to FIG. 2.

In operation 304, the synthetic data generation platform 104 can associate (e.g., link, map) one or more scenarios (e.g., application domains, applications, use cases, contexts, conditions, operational domains) with the observed dataset in which the dataset is configured to be applied in. The scenarios refer to specific contexts or use cases in which the observed dataset is intended to be used. In some implementations, scenarios can indicate a degree of sensitivity (e.g., highly confidential), operational domain (e.g., finance, healthcare), guideline (e.g., privacy regulation), and so forth. For example, users can classify the dataset based on its sensitivity level, such as public, internal, confidential, or highly confidential, to specify the level of data anonymization used when generating the synthetic data.

In operation 306, the synthetic data generation platform 104 can identify (e.g., associate, link, map) a subset of the set of attributes to be anonymized and/or depersonalized within the observed dataset (e.g., using the scenarios). The subset of attributes refers to specific data fields within the observed dataset that are selected for anonymization. In some implementations, the users can manually select the attributes to be anonymized and/or depersonalized.

In some implementations, the synthetic data generation platform 104 can automatically identify the subset of attributes to be anonymized and/or depersonalized based on predefined rules or machine learning models. For example, the rules can be derived from privacy regulations, organizational policies, or other guidelines that specify one or more data types to be anonymized and/or depersonalized. In some implementations, one or more machine learning (ML) models can be trained to recognize sensitive attributes by identify patterns in the data and identifying fields that are likely to contain personal information. For example, the ML models can use the format of the data (e.g., patterns of digits and letters), the presence of special characters (e.g., “@” in email addresses), the length of the data, the context in which the data appears (e.g., column names or surrounding text), and so forth to identify the patterns.

The subset of attributes can be, for example, a single variable/characteristic, a segment (e.g., a group of variables), and/or all attributes of the set of attributes. Each attribute of the segment can share a common attribute identifier. The attribute identifier can be, for example, an application domain (e.g., finance, health), an operational context (e.g., verification, audit), a user role (e.g., customer, administrator), and so forth. In some implementations, the identified subset of attributes is specified by a user of a computing device. The user can instruct the synthetic data generation platform 104 to generate a set of synthetic data for a particular combination of attributes. For instance, the synthetic data generation platform 104 can implement a graphical user interface (GUI) with checkboxes, dropdown menus, and search functionalities that enables the user to navigate through the available attributes and select one or more.

In operation 308, the synthetic data generation platform 104 can generate (e.g., using a first set of AI models) a set of synthetic values of the identified subset of attributes using the observed dataset, the identified subset of attributes, and/or corresponding observed values of the identified subset of attributes. The synthetic values are artificially generated data points that replace the original values in the identified subset of attributes.

In some implementations, the synthetic values are generated directly from the actual data, with built-in provisions to anonymize and/or depersonalize the data during the creation process. The synthetic values can be, for example, a number, a sequence of numbers, or digital data satisfying one or more statistical tests for randomness (e.g., Kolmogorov-Smirnov test, entropy, and so forth) but produced by a definite mathematical procedure (e.g., data masking, pseudonymization, generalization). For example, the synthetic data generation platform 104 can replace sensitive data elements (i.e., observed values of the identified subset of attributes) with random characters or symbols, replace identifiers with pseudonyms, and/or replace detailed data with broader categories (e.g., replacing specific ages with age ranges).

In some implementations, the synthetic data generation platform 104 can first anonymize and/or depersonalize the actual data by, for example, removing any personal information. Once the data is anonymized and/or depersonalized, synthetic values can be created from the depersonalized dataset. In this manner, the synthetic values generated are unable to be reverse-engineered and are more likely to comply with various data privacy regulations.

Additionally, the synthetic data generation platform 104 can create a mask for anonymizing and/or depersonalizing the observed values. The mask can be saved and subsequently applied to other data (e.g., data that is similar to the original data, the original data itself, different data, and so forth). For example, the synthetic data generation platform 104 can define a set of transformation rules applicable across datasets. For example, a rule for names can specify that all values in the column “Names” are replaced with random strings of characters, names from a predefined list, and so forth. Once the transformation rules are defined, the transformation rules can be saved as part of the anonymization/depersonalization mask. The mask can be versioned to keep track of changes or updates to the transformation rules. The saved mask can be applied to other datasets. For example, if a new dataset is collected that contains similar types of data, the anonymization/depersonalization mask can be applied to transform the identified attributes according to the predefined rules.

In some implementations, the synthetic data generation platform 104 can identify the distribution and characteristics of the observed data and generate synthetic values that follow the same or similar patterns. For example, if the original dataset contains ages that are normally distributed, the synthetic data generation platform 104 can generate synthetic ages that follow a similar normal distribution with a similar variance and/or mean. Additionally or alternatively, the synthetic data generation platform 104 can identify the relationships between different attributes in the observed dataset and generate synthetic values that maintain the relationships. To preserve correlations between variables in the synthetic data, the synthetic data generation platform 104 can calculate the correlation coefficient between the attributes in the observed dataset. For example, if the synthetic data generation platform 104 determines that age and income have a correlation coefficient of 0.7, the synthetic data generation platform 104 can generate synthetic values for age and income so that the synthetic data exhibits a similar correlation coefficient. In some implementations, synthetic values can be generated using machine models such as generative adversarial networks (GANs). GANs consist of two neural networks, a generator and a discriminator, that can be trained together in an adversarial manner. The generator can create synthetic data, while the discriminator can evaluate the quality of the synthetic data by comparing it to the original data.

In operation 310, the synthetic data generation platform 104 can generate (e.g., via a second set of AI models that are the same as or different from the first set of AI models) a tracking relationship value between the set of synthetic data and the observed dataset for one or more benchmarks by comparing the observed values of the identified subset of attributes and the set of synthetic values of the identified subset of attributes. In some implementations, the synthetic data generation platform 104 can calculate the tracking relationship value by determining whether the correlation between attributes in the synthetic data is within a certain threshold of the correlation in the observed data.

Additionally, the tracking relationship value can be generated by comparing the synthetic data against particular guidelines (e.g., a particular country's privacy regulations) or benchmarks (e.g., statistical properties of certain variables such as gender, income, geographic location, zip codes, and so forth). The synthetic data generation platform 104 can evaluate whether the distribution of synthetic values matches the distribution of observed values. For example, benchmarks can include gender, where the platform ensures that the distribution of gender in the synthetic data matches the observed data to preserve the proportion of male and female individuals. The synthetic data generation platform 104 can use statistical tests (e.g., mean absolute error, mean squared error, and so forth) to determine if the differences between the observed and synthetic data are beyond a certain threshold. In some implementations, the synthetic data generation platform 104 can evaluate the preservation of higher-order relationships, such as interactions between multiple attributes, to ensure that the synthetic data captures the complexity of the original dataset.

In some implementations, the synthetic data generation platform 104 can aggregate all benchmarks and calculate a weighted average. The synthetic data generation platform 104 can assign different weights to each benchmark based on their importance or relevance to the specific scenario (e.g., the associated scenario defines a set of weights for the set of benchmarks). For instance, in a healthcare dataset, benchmarks related to patient demographics can be given higher weights compared to other attributes. By calculating a weighted average of the tracking relationship values for each benchmark, the synthetic data generation platform 104 can measure the difference between the weighted average and a predefined threshold to generate the tracking relationship value.

In some implementations, the synthetic data generation platform 104 can group benchmarks together based on the benchmarks' characteristics and/or the relationships between the benchmarks. For example, benchmarks related to demographic attributes such as age, gender, and ethnicity can be grouped together, while benchmarks related to financial attributes such as income, expenditure, and credit score can form another group. By grouping benchmarks, the In some implementations, the synthetic data generation platform 104 can evaluate the synthetic data's quality within each group separately. For instance, if the tracking relationship value for the demographic group is high, the platform can apply programmatic workflows to adjust the synthetic values of demographic attributes while keeping the financial attributes unchanged.

The threshold can be dynamically adjusted based on scenario or set by the user. In some implementations, the synthetic data generation platform 104 dynamically adjusts the thresholds based on the associated scenario. For example, in a scenario where high accuracy is desired, such as in medical research, the thresholds can be set higher to ensure that the synthetic data more closely matches the observed data.

In some implementations, the tracking relationship value generated by the synthetic data generation platform 104 can indicate a degree of anonymization in the synthetic data. To measure and mitigate the risk of re-identification, the synthetic data generation platform 104 can validate that each record in the dataset is indistinguishable from at least other records with respect to certain identifying attributes. For example, the synthetic data generation platform 104 can identify quasi-identifiers—attributes that, when combined, can potentially identify individuals (e.g., age, gender, and zip code). The synthetic data generation platform 104 can group records that share the same values for these quasi-identifiers, ensuring that each group contains at least a certain number of records so that it is difficult to single out any individual record based on these attributes.

In operation 312, the synthetic data generation platform 104 can, using the generated tracking relationship value, automatically execute one or more programmatic workflows to modify one or more synthetic values of the set of synthetic values of the identified subset of attributes. The programmatic workflows can modify the synthetic values using methods such as re-sampling, re-weighting, or applying transformation functions to better align certain characteristics of the synthetic data (e.g., correlation, distribution, and so forth) with the observed data. The synthetic data generation platform 104 can iteratively adjusting one or more of: 1) weights, 2) biases, or 3) activation functions of the AI models used to generate the synthetic values to reduce the tracking relationship value. In some implementations, the programmatic workflows are rule-based adjustments, where the synthetic data generation platform 104 applies predefined rules to modify the synthetic values based on the tracking relationship value. For instance, if the tracking relationship value indicates that the synthetic data has a higher variance than the observed data, the synthetic data generation platform 104 can apply a particular rule to scale down the synthetic values to reduce the variance.

In some implementations, the synthetic data generation platform 104 can determine whether the tracking relationship value satisfies a predetermined threshold of the one or more benchmarks. In response to the tracking relationship value failing to satisfy the predetermined threshold, the synthetic data generation platform 104 can regenerate the set of synthetic data. In response to the tracking relationship value satisfying the predetermined threshold, the synthetic data generation platform 104 can cause display of the set of synthetic data on the computing device. Further methods of regenerating the synthetic data are discussed with reference to FIG. 2.

### Example Implementation of the Models of the Synthetic Data Generation Platform

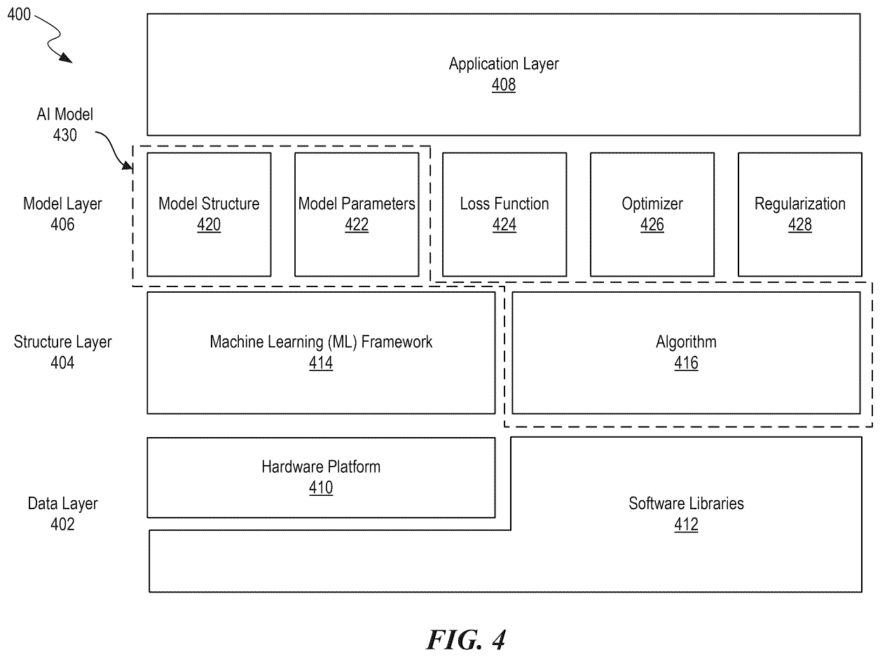

FIG. 4 illustrates a layered architecture of an AI system 400 that can implement the ML models of the synthetic data generation platform 104 of FIG. 1. Example ML models can include the models executed by the synthetic data generation platform 104, such as remediation models, anomaly detection models, and so forth. Accordingly, the AI models of the synthetic data generation platform can include one or more components of the AI system 400.

As shown, the AI system 400 can include a set of layers, which conceptually organize elements within an example network topology for the AI system's architecture to implement a particular AI model. Generally, an AI model is a computer-executable program implemented by the AI system 400 that analyses data to make predictions. Information can pass through each layer of the AI system 400 to generate outputs for the AI model. The layers can include a data layer 402, a structure layer 404, a model layer 406, and an application layer 408. The algorithm 416 of the structure layer 404 and the model structure 420 and model parameters 422 of the model layer 406 together form an example AI model. The optimizer 426, loss function engine 424, and regularization engine 428 work to refine and optimize the AI model, and the data layer 402 provides resources and support for application of the AI model by the application layer 408.

The data layer 402 acts as the foundation of the AI system 400 by preparing data for the AI model. As shown, the data layer 402 can include two sub-layers: a hardware platform 410 and one or more software libraries 412. The hardware platform 410 can be designed to perform operations for the AI model and include computing resources for storage, memory, logic and networking, such as the resources described in relation to FIG. 5. The hardware platform 410 can process amounts of data using one or more servers. The servers can perform backend operations such as matrix calculations, parallel calculations, machine learning (ML) training, and the like. Examples of servers used by the hardware platform 410 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 410 can include computing resources, (e.g., servers, memory, etc.) offered by a cloud services provider. The hardware platform 410 can also include computer memory for storing data about the AI model, application of the AI model, and training data for the AI model. The computer memory can be a form of random-access memory (RAM), such as dynamic RAM, static RAM, and non-volatile RAM.

The software libraries 412 can be thought of suites of data and programming code, including executables, used to control the computing resources of the hardware platform 410. The programming code can include low-level primitives (e.g., fundamental language elements) that form the foundation of one or more low-level programming languages, such that servers of the hardware platform 410 can use the low-level primitives to carry out specific operations. The low-level programming languages do not require much, if any, abstraction from a computing resource's instruction set architecture, enabling them to run quickly with a small memory footprint. Examples of software libraries 412 that can be included in the AI system 400 include INTEL Math Kernel Library, NVIDIA cuDNN, EIGEN, and OpenBLAS.

The structure layer 404 can include an ML framework 414 and an algorithm 416. The ML framework 414 can be thought of as an interface, library, or tool that enables users to build and deploy the AI model. The ML framework 414 can include an open-source library, an API, a gradient-boosting library, an ensemble method, and/or a deep learning toolkit that work with the layers of the AI system facilitate development of the AI model. For example, the ML framework 414 can distribute processes for application or training of the AI model across multiple resources in the hardware platform 410. The ML framework 414 can also include a set of pre-built components that have the functionality to implement and train the AI model and enable users to use pre-built functions and classes to construct and train the AI model. Thus, the ML framework 414 can be used to facilitate data engineering, development, hyperparameter tuning, testing, and training for the AI model. Examples of ML frameworks 414 that can be used in the AI system 400 include TENSORFLOW, PYTORCH, SCIKIT-LEARN, KERAS, LightGBM, RANDOM FOREST, and AMAZON WEB SERVICES.

The algorithm 416 can be an organized set of computer-executable operations used to generate output data from a set of input data and can be described using pseudocode. The algorithm 416 can include complex code that enables the computing resources to learn from new input data and create new/modified outputs based on what was learned. In some implementations, the algorithm 416 can build the AI model through being trained while running computing resources of the hardware platform 410. This training enables the algorithm 416 to make predictions or decisions without being explicitly programmed to do so. Once trained, the algorithm 416 can run at the computing resources as part of the AI model to make predictions or decisions, improve computing resource performance, or perform tasks. The algorithm 416 can be trained using supervised learning, unsupervised learning, semi-supervised learning, and/or reinforcement learning.

Using supervised learning, the algorithm 416 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of dataset 102 in FIG. 1) from various source computing systems described in relation to FIG. 1. Furthermore, training data can include pre-processed data generated by various engines of the synthetic data generation platform 104 described in relation to FIG. 1. The user may label the training data based on one or more classes and trains the AI model by inputting the training data to the algorithm 416. The algorithm determines how to label the new data based on the labeled training data. The user can facilitate collection, labeling, and/or input via the ML framework 414. In some instances, the user may convert the training data to a set of feature vectors for input to the algorithm 416. Once trained, the user can test the algorithm 416 on new data to determine if the algorithm 416 is predicting accurate labels for the new data. For example, the user can use cross-validation methods to test the accuracy of the algorithm 416 and retrain the algorithm 416 on new training data if the results of the cross-validation are below an accuracy threshold.

Supervised learning can include classification and/or regression. Classification techniques include teaching the algorithm 416 to identify a category of new observations based on training data and are used when input data for the algorithm 416 is discrete. Said differently, when learning through classification techniques, the algorithm 416 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 416 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 416 is continuous. Regression techniques can be used to train the algorithm 416 to predict or forecast relationships between variables. To train the algorithm 416 using regression techniques, a user can select a regression method for estimating the parameters of the model. The user collects and labels training data that is input to the algorithm 416 such that the algorithm 416 is trained to understand the relationship between data features and the dependent variable(s). Once trained, the algorithm 416 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 416 learns patterns from unlabeled training data. In particular, the algorithm 416 is trained to learn hidden patterns and insights of input data, which can be used for data exploration or for generating new data. Here, the algorithm 416 does not have a predefined output, unlike the labels output when the algorithm 416 is trained using supervised learning. Said another way, unsupervised learning is used to train the algorithm 416 to find an underlying structure of a set of data, group the data according to similarities, and represent that set of data in a compressed format. The synthetic data generation platform 104 can use unsupervised learning to identify patterns in claim history (e.g., to identify particular event sequences) and so forth. In some implementations, performance of the AI models of the data management platform that can use unsupervised learning is improved because the incoming dataset 102 is pre-processed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 416 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 416 may be trained to be an Isolation Forest, local outlier factor (LOF) algorithm, or K-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 416 include factor analysis, item response theory, latent profile analysis, and latent class analysis.

The model layer 406 implements the AI model using data from the data layer and the algorithm 416 and ML framework 414 from the structure layer 404, thus enabling decision-making capabilities of the AI system 400. The model layer 406 includes a model structure 420, model parameters 422, a loss function engine 424, an optimizer 426, and a regularization engine 428.

The model structure 420 describes the architecture of the AI model of the AI system 400. The model structure 420 defines the complexity of the pattern/relationship that the AI model expresses. Examples of structures that can be used as the model structure 420 include decision trees, support vector machines, regression analyses, Bayesian networks, Gaussian processes, genetic algorithms, and artificial neural networks (or, simply, neural networks). The model structure 420 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 420 may include one or more hidden layers of nodes between the input and output layers. The model structure 420 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 422 represent the relationships learned during training and can be used to make predictions and decisions based on input data. The model parameters 422 can weight and bias the nodes and connections of the model structure 420. For instance, when the model structure 420 is a neural network, the model parameters 422 can weight and bias the nodes in each layer of the neural networks, such that the weights determine the strength of the nodes and the biases determine the thresholds for the activation functions of each node. The model parameters 422, in conjunction with the activation functions of the nodes, determine how input data is transformed into desired outputs. The model parameters 422 can be determined and/or altered during training of the algorithm 416.

The loss function engine 424 can determine a loss function, which is a metric used to evaluate the AI model's performance during training. For instance, the loss function engine 424 can measure the difference between a predicted output of the AI model and the actual output of the AI model and is used to guide optimization of the AI model during training to minimize the loss function. The loss function may be presented via the ML framework 414, such that a user can determine whether to retrain or otherwise alter the algorithm 416 if the loss function is over a threshold. In some instances, the algorithm 416 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 426 adjusts the model parameters 422 to minimize the loss function during training of the algorithm 416. In other words, the optimizer 426 uses the loss function generated by the loss function engine 424 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 426 used may be determined based on the type of model structure 420 and the size of data and the computing resources available in the data layer 402.

The regularization engine 428 executes regularization operations. Regularization is a technique that prevents over-and under-fitting of the AI model. Overfitting occurs when the algorithm 416 is overly complex and too adapted to the training data, which can result in poor performance of the AI model. Underfitting occurs when the algorithm 416 is unable to recognize even basic patterns from the training data such that it cannot perform well on training data or on validation data. The optimizer 426 can apply one or more regularization techniques to fit the algorithm 416 to the training data properly, which helps constraint the resulting AI model and improves its ability for generalized application. Examples of regularization techniques include lasso (L1) regularization, ridge (L2) regularization, and elastic (L1 and L2 regularization).

The application layer 408 describes how the AI system 400 is used to solve problem or perform tasks. In an example implementation, the application layer 408 can include a front-end user interface of the synthetic data generation platform 104.

### Example Computing Environment of the Data Management Platform

FIG. 5 is a block diagram showing some of the components typically incorporated in at least some of the computer systems and other devices 500 on which the disclosed system operates. As shown, an example computer system 500 can include: one or more processors 502, main memory 508, non-volatile memory 512, a network interface device 514, video display device 520, an input/output device 522, a control device 524 (e.g., keyboard and pointing device), a drive unit 526 that includes a machine-readable medium 528, and a signal generation device 532 that are communicatively connected to a bus 518. The bus 518 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 514 enables the computer system 500 to exchange data in a network 516 with an entity that is external to the computing system 500 through any communication protocol supported by the computer system 500 and the external entity. Examples of the network interface device 514 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 508, non-volatile memory 512, machine-readable medium 528) can be local, remote, or distributed. Although shown as a single medium, the machine-readable medium 528 can include multiple media (e.g., a centralized/distributed database and/or associated caches and servers) that store one or more sets of instructions 530. The machine-readable (storage) medium 528 can include any medium that is capable of storing, encoding, or carrying a set of instructions for execution by the computer system 500. The machine-readable medium 528 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 510, 530) set at various times in various memory and storage devices in computing device(s). When read and executed by the processor 502, the instruction(s) cause the computer system 500 to perform operations to execute elements involving the various aspects of the disclosure.

### Conclusion

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration, but that various modifications can be made without deviating from the scope of the invention. Accordingly, the invention is not limited except as by the appended claims.

1. A computer-implemented method, executed on a hardware device comprising at least one processor and memory, for automatically executing programmatic workflows to generate and calibrate synthetic datasets using an artificial intelligence (AI) model, the computer-implemented method comprising:
accepting, via one or more electrical signals received by the hardware device, a dataset comprising (a) an attribute set and (b) an observed value set of the attribute set;
mapping one or more application domains to the dataset into which the dataset is to be configured to be applied;
using the one or more application domains, identifying an attribute subset to be masked within the dataset;
using a first AI model set executed via the at least one processor, generating a synthetic value set of the identified attribute subset using the identified attribute subset and corresponding observed values of the identified attribute subset,
wherein the first AI model set is trained on the dataset to output data in accordance with one or more statistical metric values of the observed values of the dataset, and
wherein the synthetic value set are configured to replace the corresponding observed values of the identified attribute subset in the dataset;
subsequent to the generation of the synthetic value set, evaluating the synthetic value set using a second AI model set executed via the at least one processor by generating a tracking error metric value set between the synthetic value set and the corresponding observed values of the identified attribute subset for one or more benchmarks by:
inputting (a) the synthetic value set, (b) the corresponding observed values, (c) the one or more application domains into the second AI model set,
comparing, using the second AI model set, (a) the observed values of the identified attribute subset with (b) the synthetic value set of the identified attribute subset as applied in the one or more application domains,
wherein the second set of AI models is configured to output an evaluation result indicating whether the set of synthetic values satisfies one or more thresholds relative to the corresponding observed values, and
determining, for each benchmark of the one or more benchmarks, the tracking error metric value using the evaluation result,
wherein the tracking error metric value represents a degree of alignment between (a) the observed values of the identified attribute subset and (b) the synthetic value set of the identified attribute subset as applied in the one or more application domains; and
perform, via the at least one processor of the hardware device, one or more computer-implemented processing tasks with respect to the synthetic value set of the identified attribute subset based at least in part on the tracking error metric value set,
wherein the one or more computer-implemented processing tasks are configured to modify the first AI model set by iteratively adjusting one or more of: (a) weights, (b) biases, or (c) activation functions applied to the first AI model set to reduce the tracking error metric value set below a predetermined threshold, and
wherein the at least one processor is configured to output updated synthetic values as electrical signals to one or more of: the memory or a display device.

2. The computer-implemented method of claim 1, further comprising:
configuring for display, via a user interface of a computing device, a compliance report including (a) a first representation of the generated tracking error metric value set and (b) a second representation of the one or more benchmarks,
wherein the compliance report is configured to verify compliance of the synthetic value set with a set of guidelines associated with the one or more application domains.

3. The computer-implemented method of claim 1, further comprising:
applying a data mask to the corresponding observed values of the identified attribute subset of the dataset by replacing original data values with pseudorandom values.

4. (canceled)

5. The computer-implemented method of claim 1, further comprising:
identifying personal information within the dataset; and
replacing the identified personal information with the synthetic value set.

6. The computer-implemented method of claim 1, wherein at least one model in the first AI model set is same as at least one model in the second AI model set.

7. The computer-implemented method of claim 1, wherein the attribute set is a first attribute set, wherein the observed value set is a first observed value set, wherein the dataset is a first dataset, further comprising:
generating a data mask configured to anonymize the observed values of the identified attribute subset of the first dataset;
obtaining a second dataset including (a) a second attribute set and (b) a second observed value set of the second attribute set; and
applying the data mask on the second observed value set of the second attribute set.

8. A non-transitory, computer-readable storage medium comprising instructions thereon, wherein the instructions, when executed by at least one data processor of a system, cause the system to:
obtain a dataset including (a) an attribute set and (b) an observed value set corresponding to the attribute set;
associate one or more target applications with the dataset into which the dataset is configured to be applied;
using the one or more target applications, identify an observed value subset of the observed value set to be modified within the dataset, the observed value subset corresponding to a subset of the attribute set;
using a first AI model set, generate a synthetic value set corresponding to the observed value subset using the observed value subset,
wherein the first AI model set is trained on the dataset to output data in accordance with one or more statistical metric values of the observed values of the dataset;
subsequent to the generation of the synthetic value set, evaluating the synthetic value set using a second AI model set, generate a score set between the synthetic value set and the observed value subset for comparison to one or more benchmarks by:
inputting (a) the synthetic value set, (b) the observed value subset, and (c) the one or more target applications into the second AI model set,
comparing, using the second AI model set, the observed value subset with the synthetic value set as applied in the one or more target applications,
wherein the second set of AI models is configured to output an evaluation result indicating whether the set of synthetic values satisfies one or more thresholds relative to the corresponding observed values, and
determining, for each benchmark of the one or more benchmarks, the score using the evaluation result,
wherein the score represents a degree of alignment between (a) the observed value subset and (b) the synthetic value set as applied in the one or more target applications; and
perform one or more computer-implemented processing tasks with respect to one or more synthetic values of the synthetic value set based at least in part on the score set,
wherein the one or more computer-implemented processing tasks are configured to modify the first AI model set by iteratively adjusting one or more of: (a) weights, (b) biases, or (c) activation functions applied to the first AI model set to cause the score set to satisfy a predetermined threshold.

9. The non-transitory, computer-readable storage medium of claim 8, wherein the dataset includes one or more of: (a) actual data, (b) copies of the actual data, or 3) additional data derived from the actual data.

10. The non-transitory, computer-readable storage medium of claim 8, wherein automatically executing the one or more computer-implemented processing tasks comprises:
identifying one or more synthetic values associated with the generated score set,
adjusting one or more parameters of the first AI model set associated with the one or more synthetic values, and
regenerating the synthetic value set using the adjusted parameters of the first AI model set.

11. The non-transitory, computer-readable storage medium of claim 8, wherein the instructions further cause the system to:
display, on a user interface of a computing device, a compliance report including (a) a first representation of the generated score set and (b) a second representation of the one or more benchmarks,
wherein the compliance report is configured to verify compliance of the synthetic value set with a guideline set associated with the one or more target applications.

12. The non-transitory, computer-readable storage medium of claim 8, wherein the subset of the attribute set comprises a single attribute of the attribute set.

13. The non-transitory, computer-readable storage medium of claim 8, wherein the subset of the attribute set comprises a attribute segment within the attribute set, and wherein each attribute of the attribute segment shares a common attribute identifier of the attribute.

14. The non-transitory, computer-readable storage medium of claim 8, wherein the instructions further cause the system to:
modify the dataset by removing the observed value set from the dataset, and
generate the synthetic value set using the modified dataset.

15. A system comprising:
at least one hardware processor of a hardware device; and
at least one non-transitory memory storing instructions, which, when executed by the at least one hardware processor, cause the system to:
accept, via one or more electrical signals received by the hardware device, each dataset including (a) an attribute set and (b) an observed value set corresponding to the attribute set;
associate one or more target applications with the dataset to which the dataset is configured to be applied;
using the one or more target applications, identify an observed value subset of the observed value set to be modified within the dataset, the observed value subset corresponding to a subset of the attribute set;
using a first AI model set executed via the at least one hardware processor, generate a synthetic value set corresponding to the observed value subset using the observed value subset,
wherein the first AI model set is trained on the dataset to output data in accordance with one or more statistical metric values of the observed values of the dataset;
subsequent to the generation of the synthetic value set, evaluating the synthetic value set by inputting (a) the synthetic value set, (b) the observed value subset, and (c) the one or more target applications into a second AI model set, via the at least one hardware processor, to output a score set between the synthetic value set and the observed value subset for comparison to one or more benchmarks,
wherein the second set of AI models is configured to output an evaluation result indicating whether the set of synthetic values satisfies one or more thresholds relative to the corresponding observed values, and
wherein the score set is determined using the evaluation result; and
perform, via the at least one hardware processor of the hardware device, one or more computer-implemented processing tasks with respect to one or more synthetic values of the synthetic value set corresponding to the identified attribute subset based at least in part on the score set,
wherein the at least one hardware processor is configured to output updated synthetic values as electrical signals to one or more of: the at least one non-transitory memory or a display device.

16. The system of claim 15, wherein the dataset includes one or more of: (a) actual data, (b) copies of the actual data, or (c) additional data derived from the actual data.

17. The system of claim 15, wherein the one or more computer-implemented processing tasks include:
adjusting one or more parameters of the first AI model set associated with one or more synthetic values, and
regenerating the synthetic value set using the adjusted parameters of the first AI model set.

18. The system of claim 15, wherein the system is further caused to:
apply a data mask to the observed value subset of the dataset by replacing original data values with pseudorandom values.

19. The system of claim 15, wherein the system is further caused to:
iteratively adjust one or more of: (a) weights, (b) biases, or (c) activation functions applied within the first AI model set to reduce the score set below a predetermined threshold.

20. The system of claim 15, wherein the system is further caused to:
modify the dataset by removing observed values of the observed value set from the dataset, and
generate the synthetic value set using the modified dataset.

21. The system of claim 15, wherein the system is further caused to:
determine, for each benchmark of the one or more benchmarks, a tracking error metric value that represents a degree of alignment between (a) the observed values of the identified attribute subset and (b) the synthetic value set of the identified attribute subset as applied in the one or more target applications.
